(19) United States
(12) Patent Application Publication
(10) Pub. No.: US 2010/0225178 A1
(43) Pub. Date: Sep. 9, 2010

(54) Laser power distribution

(76) Inventor: Denis Alan De Shon, Baton Rouge, LA (US)

Correspondence Address: DENIS ALAN DE SHON, 7242 SEVEN OAKS AVENUE, BATON ROUGE, LA, 70806, US

(21) Appl. No.: 12/380,922

(22) Filed: Mar. 5, 2009

(51) Int. Cl. H02J 17/00

(52) U.S. Cl. 307/149

(57) ABSTRACT

This invention obviates the need for expensive high-tension towers and wires for the wholesale distribution of electricity. Instead, a laser beam is transmitted, which, when received and converted from photons to electrons by a remote site's photo-voltaic-array, can be distributed as electricity.

A high power laser projector is mounted on a tower so as to increase line-of-sight transmission distance and emits a laser beam directed toward the receiving site.

Located at the receiving site is a photo-voltaic-array which captures the beamed energy and converts it into electric current, which is then put to use by distribution to users or stored in capacitors or batteries.

### SUMMARY OF THE INVENTION

The invention is a Laser Projector which is powered by a Power Source which provides electric power to pump the Laser. A Laser Beam is projected toward the Receiver, which has a Photo-voltaic-Array which captures the Photo energy of the projected beam and converts it back into electric current which is distributed to the retail user, or stored in capacitors or batteries.

### BRIEF DESCRIPTION OF THE DRAWINGS

Referring to the Drawings, which are for illustrative purposes only:

FIG. 1 is a schematic view of the components of the distribution system in which a Laser Projector (1) is mounted on a Tower (2), which increases line-of-sight transmission distance, and is powered by the electricity from a Power Source (3). A Laser Beam (4) is projected toward the Receiver (5) where it is intercepted by the Photo-voltaic-Array (6), which converts the beamed photo-energy back into electricity.

### DESCRIPTION OF THE PRESENT EMBODIMENT

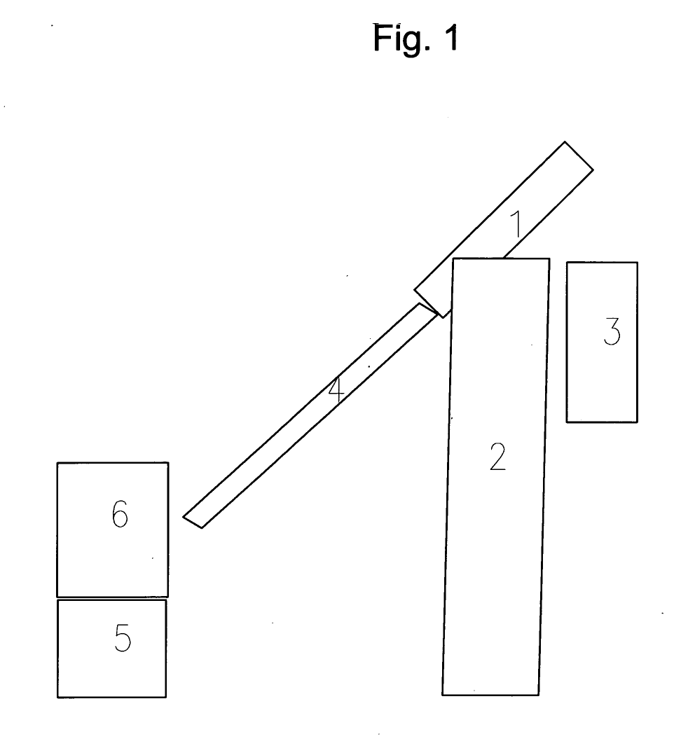

FIG. 1 is a schematic view of the components of the distribution system in which a Laser Projector (1) is mounted on a Tower (2) and is powered by the electricity from a Power Source (3). A Laser Beam (4) is projected toward the Receiver (5) where it is intercepted by the Photo-voltaic-Array (6).

### OBJECTS AND ADVANTAGES OF THE INVENTION

It is an object of the invention to provide economical wholesale distribution of power without the need for expensive High-tension Lines and Towers. Rather, a Laser Beam is projected to send power to the receivers photo-electric-array, which may be distributed to retail users as electricity.

It is another object of the invention to provide apparatus of this character that is simple in construction and operation.

It is a further object of the invention to provide apparatus of this character that is relatively inexpensive to manufacture and maintain.

The characteristics and advantages of the invention are further sufficiently referred to in conjunction with the following detailed description of the accompanying drawing, which represents one embodiment.

After considering this example, skilled persons will understand that many variations may be made without departing from the principles disclosed and I contemplate the employment of any structure, arrangements or modes of operation that are properly within the scope of the appended claims.

I claim:

1. Laser powered distribution of wholesale power comprising:
a laser projector, mounted on a tower, powered by a power supply providing electricity to pump the laser, which projects a laser beam toward a receiver, and which beam is captured by the photo-voltaic-array of the receiver and converted back into electricity for distribution to retail users.
